(19) United States
(12) Patent Application Publication
(10) Pub. No.: US 2021/0141601 A1
(43) Pub. Date: May 13, 2021

(54) DIGITAL CALCULATION PROCESSING CIRCUIT

(71) Applicant: MITSUBISHI ELECTRIC CORPORATION, Tokyo (JP)

(72) Inventors: Naohisa Takayama, Tokyo (JP); Osamu Wada, Tokyo (JP); Kenichi Tajima, Tokyo (JP)

(73) Assignee: MITSUBISHI ELECTRIC CORPORATION, Tokyo (JP)

(21) Appl. No.: 16/476,733

(22) PCT Filed: Feb. 22, 2017
(86) PCT No.: PCT/JP2017/006547

§ 371 Date: Jul. 9, 2019

(51) Int. Cl. G06F 5/01; G06F 7/544; G06F 7/523; G06F 7/50

(52) U.S. Cl. CPC G06F 5/01; G06F 7/50; G06F 7/523; G06F 7/5443

(57) ABSTRACT

A determination unit determines whether data to be inputted to each of first and second calculation units has a value greater than a specific positive value or a value less than a specific negative value. In such a case, the first calculation unit performs a calculation. The first calculation unit includes a data shifter bit-shifting input data by a set bit shift amount toward less significant bits, and reduces the bit width by the set bit shift amount, a multiplier multiplying together the data-shifted data, a cumulative addition unit cumulatively adding up results of the multiplication, and an inverse data shifter bit-shifting output data from the cumulative addition unit toward more significant bits by the set bit shift amount toward less significant bit positions, and increasing the bit width by the set bit shift amount.

### TECHNICAL FIELD

The present invention relates to a digital calculation processing circuit that performs a multiplication operation among pieces of data being inputted in time series, and then performs a calculation of cumulative addition on results of this multiplication operation.

### BACKGROUND ART

A digital calculation processing circuit performs a multiplication operation among pieces of data being inputted in time series, and then obtains output data by performing cumulative addition on results of this multiplication operation. Conventionally, in a data shift performed in each of a preceding stage and a subsequent stage of an adder unit for cumulative addition, a bit shift operation to reduce the data bit width is performed, and thus power consumption during operation is reduced.

### CITATION LIST

### Patent Literatures

Patent Literature 1: JP 2000-29664 A

### SUMMARY OF INVENTION

### Technical Problem

However, since the conventional digital calculation processing circuit described above is configured to perform a bit shift operation after the multiplication, although the power consumption in the addition operation can be reduced, the power consumption in the multiplication operation cannot be reduced. From this viewpoint, there is a demand for further reduction in power consumption.

This invention has been made to solve the above problem, and it is an object of this invention to provide a digital calculation processing circuit capable of reducing power consumption during operation.

### Solution to Problem

A digital calculation processing circuit according to this invention includes: a first calculation unit and a second calculation unit each performing a calculation including multiplication of data being inputted in time series and data being inputted in time series, and cumulative addition of results of the multiplication; a determination unit determining whether each of the data to be inputted to the first calculation unit and the data to be inputted to the second calculation unit has a value greater than or equal to a specific positive value or a value less than or equal to a specific negative value; a control unit performing control to cause the first calculation unit to perform the calculation if a determination result of the determination unit indicates that the value is greater than or equal to the specific positive value or is less than or equal to the specific negative value, and otherwise, to cause the second calculation unit to perform the calculation; and an aggregating calculation unit generating output data by performing an addition operation on a result of the calculation of the first calculation unit and a result of the calculation of the second calculation unit. The first calculation unit includes: a data shifter performing bit-shifting of input data by a set bit shift amount toward less significant bit positions, and performing reduction of a bit width of the input data by an amount of the bit-shifting; a multiplier multiplying together pieces of output data from the data shifter, a cumulative addition unit cumulatively adding up output data from the multiplier, and an inverse data shifter performing bit-shifting of output data from the cumulative addition unit toward more significant bit positions to compensate the amount of the bit-shifting toward the less significant bit positions performed by the data shifter, and increasing a bit width thereof by the amount of the bit-shifting toward the more significant bit positions.

### Advantageous Effects of Invention

A digital calculation processing circuit according to this invention bit-shifts input data by a set number of bits toward less significant bit positions, and reduces the bit width by the number of shifted bits before performing multiplication operation between the pieces of data. Thus, power consumption during operation can be reduced.

### BRIEF DESCRIPTION OF DRAWINGS

FIG. 1 is a configuration diagram of a digital calculation processing circuit of a first embodiment of this invention.

FIG. 2 is an illustrative chart of determination threshold in the digital calculation processing circuit of the first embodiment of this invention.

FIG. 3 is a flowchart illustrating an operation of the digital calculation processing circuit of the first embodiment of this invention.

FIG. 4A is an illustrative diagram showing states of data of respective portions in the digital calculation processing circuit of the first embodiment of this invention.

FIG. 4B is an illustrative diagram showing states of data of respective portions in the digital calculation processing circuit of the first embodiment of this invention.

FIG. 5 is a configuration diagram of a digital calculation processing circuit of a second embodiment of this invention.

FIG. 6 is a flowchart illustrating an operation of the digital calculation processing circuit of the second embodiment of this invention.

### DESCRIPTION OF EMBODIMENTS

To describe the present invention in more detail, some embodiments of this invention will be described below with reference to the accompanying drawings.

### First Embodiment

FIG. 1 is a configuration diagram of a digital calculation processing circuit of this embodiment. A digital calculation processing circuit 1 shown in FIG. 1 includes a shift setting register 2, a determination unit 3, a control unit 4, a first calculation unit 5, a second calculation unit 6, an aggregating calculation unit 7, an X register 8, and a Y register 9. The shift setting register 2 is provided for setting a shift amount in a data shifter 501 in the first calculation unit 5. The determination unit 3 is a processing unit that determines whether data inputted to the first calculation unit 5 and to the second calculation unit 6 each have a value greater than or equal to a specific positive value or a value less than or equal to a specific negative value, where these specific values serve as determination thresholds. The control unit 4 performs control to cause the first calculation unit 5 to perform a calculation if the determination result of the determination unit 3 shows that a condition based on the determination thresholds is satisfied, and to cause the second calculation unit 6 to perform a calculation if the condition is not satisfied.

The first calculation unit 5 multiplies apiece of data being inputted in time series and a piece of data being inputted in time series, and cumulatively adds up results of the multiplication, and includes the data shifter 501, a first multiplier 502, a first adder 503, a first accumulator 504, and an inverse data shifter 506. The data shifter 501 is a processing unit that performs a data shift operation on data from the X register 8 and data from the Y register 9 and reduces each of their bit widths by the data shift amount on the basis of a value set by the shift setting register 2. The first multiplier 502 is a calculation unit that multiplies together the outputs from the data shifter 501. The first adder 503 is a calculation unit that adds together an output from the first multiplier 502 and an output from the first accumulator 504, and outputs the addition result to the first accumulator 504. The first accumulator 504 is a processing unit that holds a result of cumulative addition of the first adder 503. The first adder 503 and the first accumulator 504 form a first cumulative addition unit 505, which cumulatively adds up output data from the first multiplier 502. The inverse data shifter 506 is a processing unit that performs a data shift operation inverse to the shift performed by the data shifter 501, on the output from the first accumulator 504, and increases the bit width by the number of shifted bits.

The second calculation unit 6 multiplies apiece of data being inputted in time series and a piece of data being inputted in time series, and cumulatively adds up results of this multiplication, and includes a second multiplier 601, a second adder 602, and a second accumulator 603. The second multiplier 601 is a calculation unit that multiplies together the data from the X register 8 and the data from the Y register 9. The second adder 602 is a calculation unit that adds together an output from the second multiplier 601 and an output from the second accumulator 603, and outputs the addition result thereof to the second accumulator 603. The second accumulator 603 is a processing unit that holds a result of cumulative addition of the second adder 602. The second adder 602 and the second accumulator 603 form a second cumulative addition unit 604, which cumulatively adds up output data from the second multiplier 601.

The aggregating calculation unit 7 is a calculation unit that performs an addition operation on the calculation results of the first calculation unit 5 and of the second calculation unit 6 to generate output data of the digital calculation processing circuit 1, and includes a third adder 701 and a limiter 702. The third adder 701 is a calculator that adds together the calculation results of the first calculation unit 5 and of the second calculation unit 6. The limiter 702 is a processing unit for selecting a relevant data portion from the output data of the third adder 701 to obtain output data of the aggregating calculation unit 7.

Next, an operation of the digital calculation processing circuit 1 of the first embodiment will be described.

Calculation by the digital calculation processing circuit 1 will be described below in terms of calculation processing including a multiplication operation between pieces of data of signals being inputted in time series and between pieces of data of phase information being inputted in time series, or multiplication operation between two pieces of data being respectively inputted in time series, and an addition operation performed thereafter among multiple multiplication operation results stored in time series.

It is assumed here that an operation of the digital calculation processing circuit 1 is performed under the following predetermined conditions.

Firstly, each of input data (X data and Y data) received by the digital calculation processing circuit 1 and output data has a width of 16 bits.

It is assumed that in the shift setting register 2, four (4 bits) are set as the bit shift amount.

In the determination unit 3, the determination thresholds used to select either one of the first calculation unit 5 or the second calculation unit 6 as the calculation unit are, in a case where the X data and the Y data each have a bit width of 16 bits, when the X data or the Y data has a positive value, for both the X data and the Y data, set to +16384 (a positive threshold), which is half of +32768 being a value obtained by adding +1 to the maximum value of data having a width of 15 bits. This means that each of the X data and the Y data has the most significant bit of 0 and the second most significant bit of 1.

When the X data or the Y data has a negative value, for both the X data and the Y data, the determination thresholds are set to −16384 (a negative threshold), which is half of −32768 being a value obtained by adding −1 to the minimum value of data having a width of 15 bits. This means that each of the X data and the Y data has the most significant bit of 1 and the second most significant bit of 1.

In the determination unit 3, the condition for selecting the first calculation unit 5 as the calculation unit is that the value is greater than or equal to the positive threshold (+16384) in a case of a positive value for both the X data and the Y data, and that the value is less than or equal to the negative threshold (−16384) in a case of a negative value for both the X data and the Y data. This is illustrated in FIG. 2. That is, when X≥+16384 or X≤−16384 is satisfied and Y≥+16384 or Y≤−16384 is satisfied, the first calculation unit 5 is selected as the calculation unit, while X≥+16384 or X≤−16384 is satisfied and −16383≤Y≤+16383 is satisfied, the second calculation unit 6 is selected as the calculation unit. In addition, if −16383≤X≤+16383 is satisfied, both when Y≥+16384 or Y≤−16384 is satisfied and when −16383≤Y≤+16383 is satisfied, the second calculation unit 6 is selected as the calculation unit.

In this embodiment, it is assumed that each of the X data and the Y data is sinusoidal data having a value that varies 64 times in time series in one cycle, in which the first calculation unit 5 performs a process 32 times, and the second calculation unit 6 performs a process 32 times. The sum of the number of times of the process performed by the first calculation unit 5 and the number of times of the process performed by the second calculation unit 6 is the number of times of the process in one cycle, which is 64.

An operation of the digital calculation processing circuit 1 under the above conditions will now be described.

FIG. 3 is a flowchart illustrating an operation of the digital calculation processing circuit 1. FIGS. 4A and 4B are illustrative diagrams showing states of data of respective portions.

FIG. 4A illustrates, in relation to processing 50 performed by the first calculation unit, input data 101, which is each of the X data and the Y data; shifted output data 102, which is each of the outputs from the data shifter 501 respectively corresponding to the X data and to the Y data; multiplier output data 103, which is an output from the first multiplier 502; adder output data 104, which is output data from the first adder 503; accumulator output data 105, which is output data from the first accumulator 504; and inversely-shifted output data 106, which is output data from the inverse data shifter 506.

Moreover, FIG. 4B illustrates, in relation to processing 60 performed by the second calculation unit, multiplier output data 107, which is an output from the second multiplier 601; adder output data 108, which is an output from the second adder 602; and accumulator output data 109, which is an output from the second accumulator 603. FIG. 4B also illustrates, in relation to processing 70 performed by the aggregating calculation unit, adder output data 110, which is an output from the third adder 701; and circuit output data 111, which is an output from the limiter 702, and is also an output of the digital calculation processing circuit 1.

Note that, in FIGS. 4A and 4B, the numbers (0, 1, 2, . . . ) given above each data represent bit numbers. In these drawings, the leftmost bit is the MSB, and the rightmost bit is the LSB.

In the flowchart of FIG. 3, the digital calculation processing circuit 1 first receives X data in the X register 8 and Y data in the Y register 9 (step ST201). Next, the determination unit 3 determines whether both of the X data received by the X register 8 and the Y data received by the Y register 9 have a value greater than or equal to the above positive threshold (+16384) or less than or equal to the above negative threshold (−16384)(step ST202). If any of such conditions is satisfied, the determination result YES is sent to the control unit 4, and if both conditions are not satisfied, the determination result NO is sent to the control unit 4.

At step ST202, if the result of the determination by the determination unit 3 is YES, the first calculation unit 5 performs the calculation processing on the basis of a control signal provided by the control unit 4 (step ST203 to step ST207). In parallel with this, a control signal from the control unit 4 causes the clock for operating the second calculation unit 6 to stop, so that the operation of the second calculation unit 6 stops.

After the control unit 4 sends a control signal to the shift setting register 2, in the first calculation unit 5, the bit shift amount of 4 (four bits) that is set in the shift setting register 2 is sent to the data shifter 501. This causes the data shifter 501 to bit-shift each of the pieces of the input data 101, which are the X data and the Y data, by four bits toward less significant bit positions, and also to reduce the bit widths thereof from 16 to 12, thus to generate the shifted output data 102 for each of the X data and the Y data (step ST203). In this operation, the least significant four bits of the input data 101 are truncated for both the X data and the Y data.

Next, the first multiplier 502 performs a multiplication operation between the shifted output data 102 of the X data and the shifted output data 102 of the Y data (step ST204), and thus obtains the multiplication result as the multiplier output data 103. Next, the first adder 503 performs an addition operation between the multiplier output data 103 generated at step ST204 and the accumulator output data 105 (step ST205), and thus obtains the addition result as the adder output data 104. Note that the addition operation is not required when the accumulator output data 105 is in an initial state, and has a value of 0.

Next, the first accumulator 504 accumulates data that is the adder output data 104 generated at step ST205 having the least significant bit data thereof truncated (step ST206), and sends out the accumulator output data 105. The purpose of this truncation of the least significant bit is to match the bit width with the bit width of the multiplier output data 103 before performing of the addition operation with the multiplier output data 103 to be generated at step ST204 in the next cycle.

The process from step ST203 to step ST206 is repeated 32 times, which is the number of times set in the above conditions, and this cumulative addition result is provided to the inverse data shifter 506.

Next, the inverse data shifter 506 bit-shifts the accumulator output data 105 generated at step ST206 by eight bits toward more significant bit positions, then increases, accordingly, the bit width by eight bits from 24 to 32 (step ST207), and outputs the resultant data as the inversely-shifted output data 106. The purpose of this is to match the bit width with the bit width of the accumulator output data 109, which is the output data of the second calculation unit 6, by increasing the bit width by the amount of reduction in the bit width to compensate the reduction in the data bit width by eight bits in total, i.e., four bits for each of the X data and the Y data, at step ST203. Note that the inverse bit shift amount and the amount of increase in the bit width for the inverse data shifter 506 are set with the setting of the bit shift to the data shifter 501. This enables the addition operation to be performed in the third adder 701 of the aggregating calculation unit 7.

In the process of increasing the bit width at step ST207, if the accumulator output data 105 has a positive value, a bit string of “10000000” (MSB on the left side, +128 in decimal number) is complementarily added, and if the accumulator output data 105 has a negative value, a bit string of “01111111” (MSB on the left side, −129 in decimal number) is complementarily added, as the least significant eight bits. In the case of a positive value, the value that can be complementarily added ranges from “0000000” (0 in decimal number) to “1111111” (+255 in decimal number). The complementarily added value of “10000000” (+128) is the median of the range of the value that can be complementarily added in this case, and the use of this value can minimize the error. In the case of a negative value, the value that can be complementarily added ranges from “0000000” (−1 in decimal number) to “1111111” (−257 in decimal number). The complementarily added value of “01111111” (−129) is the median of the range of the value that can be complementarily added in this case, and the use of this value can suppress the maximum value of the error. In this operation, the maximum value of the error is 0.0076%.

On the other hand, at step ST202, if the result of the determination by the determination unit 3 is NO, the second calculation unit 6 performs the calculation processing on the basis of a control signal provided by the control unit 4 (step ST208 to step ST210). In parallel with this, a control signal from the control unit 4 causes the clock for operating the first calculation unit 5 to stop, so that the operation of the first calculation unit 5 stops.

In the second calculation unit 6, firstly, the second multiplier 601 performs a multiplication operation between the X data and the Y data, which are each the input data 101 (step ST208), and outputs the multiplication result as the multiplier output data 107. Next, the second adder 602 performs an addition operation between the multiplier output data 107 generated at step ST208 and the accumulator output data 109 (step ST209), and outputs the addition result as the adder output data 108. Note that the addition operation is not required when the accumulated data in the second accumulator 603 is in an initial state, and has a value of 0.

Next, the second accumulator 603 accumulates data that is the adder output data 108 generated at step ST209 having the least significant bit data thereof truncated (step ST210), and sends out the accumulator output data 109. The purpose of this truncation of the least significant bit is to match the bit width with the bit width of the multiplier output data 107 before performing of the addition operation with the multiplier output data 107 to be generated at step ST208 in the next cycle.

The process from step ST208 to step ST210 is repeated 32 times, which is the number of times set in the above conditions. This accumulator output data 109 after 32 times of repetition is the output data of the second calculation unit 6.

Next, at steps ST211 and ST212, addition operation processing is performed by the aggregating calculation unit 7. In the aggregating calculation unit 7, firstly, the third adder 701 performs an addition operation between the inversely-shifted output data 106 from the first calculation unit 5 and the accumulator output data 109 from the second calculation unit 6 (step ST211), and thus obtains the addition result as the adder output data 110. Next, the limiter 702 selects a relevant data portion (bit width: 16) from the adder output data 110 (bit width: 33) generated at step ST211, and outputs the relevant data portion as the circuit output data 111, which is the output data of the aggregating calculation unit 7 and the output data of the digital calculation processing circuit 1 (step ST212).

As described above, the digital calculation processing circuit 1 of the first embodiment can implement, in the operation thereof, a part of calculation processing by the operation by the first calculation unit 5 instead of by the operation by the second calculation unit 6, thereby enabling a reduction in the size (the number of gates) of the circuit for use in the operation. Assuming that, in the digital calculation processing circuit 1, the size of the circuit for use in the operation is proportional to the amount of power consumed by the digital calculation processing circuit 1, the power consumption of the digital calculation processing circuit 1 can be reduced in proportion to the reduction in the circuit size.

In the first embodiment, an operation that would be repeated 32 times by the second calculation unit 6 can be implemented by the first calculation unit 5. Let us assume that the power consumption of the entire digital calculation processing circuit 1 (including one addition operation in the aggregating calculation unit 7) by the second calculation unit 6 (64 times of operation in total) is 1.00. Then, the ratio of the amount of power consumed by the entire digital calculation processing circuit 1 by using the first calculation unit 5 (64 times of operation) would be 0.72. Considering the ratio of 0.5 (=32/64) of the number of times of operation performed by the first calculation unit 5, the ratio of the power consumed by the entire digital calculation processing circuit 1 in the above operation is 0.85.

Thus, the amount of power can be reduced by about 15% with respect to the power consumption of the entire digital calculation processing circuit 1.

As described above, the digital calculation processing circuit includes: a first calculation unit and a second calculation unit each performing a calculation including multiplication of data being inputted in time series and data being inputted in time series, and cumulative addition of results of the multiplication; a determination unit determining whether each of the data to be inputted to the first calculation unit and the data to be inputted to the second calculation unit has a value greater than or equal to a specific positive value or a value less than or equal to a specific negative value; a control unit performing control to cause the first calculation unit to perform the calculation if a determination result of the determination unit indicates that the value is greater than or equal to the specific positive value or is less than or equal to the specific negative value, and otherwise, to cause the second calculation unit to perform the calculation; and an aggregating calculation unit generating output data by performing an addition operation on a result of the calculation of the first calculation unit and a result of the calculation of the second calculation unit. The first calculation unit includes: a data shifter performing bit-shifting of input data by a set bit shift amount toward less significant bit positions, and performing reduction of a bit width of the input data by an amount of the bit-shifting; a multiplier multiplying together pieces of output data from the data shifter, a cumulative addition unit cumulatively adding up output data from the multiplier, and an inverse data shifter performing bit-shifting of output data from the cumulative addition unit toward more significant bit positions to compensate the amount of the bit-shifting toward the less significant bit positions performed by the data shifter, and increasing a bit width thereof by the amount of the bit-shifting toward the more significant bit positions. Thus, the power consumption during operation can be reduced.

### Second Embodiment

A digital calculation processing circuit of a second embodiment includes a setting unit that sets the bit shift amount for the shift setting register 2 and the determination threshold for the determination unit 3.

FIG. 5 is a configuration diagram of a digital calculation processing circuit of the second embodiment.

In FIG. 5, a setting unit 10 is disposed outside the main body of a digital calculation processing circuit 1a, and is a processing unit for setting the bit shift amount for use in a shift setting register 2a and for setting the determination threshold value for use in a determination unit 3a. In addition, the digital calculation processing circuit 1a is configured similarly to the digital calculation processing circuit 1 of the first embodiment illustrated in FIG. 1 except that a value of the bit shift amount is set to the shift setting register 2a in the digital calculation processing circuit 1a by the setting unit 10, and that a determination thresholds is set to the determination unit 3a by the setting unit 10, and thus the same reference characters are used to designate elements corresponding to those of FIG. 1, and a description thereof will be omitted.

FIG. 6 is a flowchart illustrating an operation of the digital calculation processing circuit of the second embodiment.

Firstly, the setting unit 10 sets, to the shift setting register 2a, the bit shift amount (bit shift amount to be set by the shift setting register 2a) for the bit-shifting performed in the data shifter 501, and sets the determination threshold for use in the determination unit 3 (step ST200). The process thereafter from step ST201 to step ST212 is the same as the corresponding process illustrated in FIG. 3, and a description thereof will thus be omitted.

Thus, the digital calculation processing circuit 1a of the second embodiment is configured so that the bit shift amount for use in the first calculation unit 5 and the determination threshold value for use in the determination unit 3a are externally set, thereby allowing the bit shift amount and the determination threshold value to be set on the basis of monitoring and determination by the user.

As described above, according to the digital calculation processing circuit of the second embodiment, the set bit shift amount, the specific positive value, and the specific negative value are externally set. Thus, the bit shift amount, the specific positive value, and the specific negative value can be easily and reliably set, in addition to achieving the effects of the first embodiment.

Note that the bit shift amount and the determination threshold in the first embodiment and in the second embodiment described above are not limited to the values described in the first embodiment and in the second embodiment, but can be selected as appropriate.

Moreover, the present invention covers any combination of the embodiments described herein, modifications of any component in the embodiments, or omissions of any component in the embodiments that fall within the scope of the invention.

### INDUSTRIAL APPLICABILITY

As described above, a digital calculation processing circuit according to this invention relates to a configuration to perform a multiplication operation on pieces of data being inputted in time series, and perform a calculation of cumulative addition on results of this multiplication operation; and is suitable for use, for example, in a digital calculation processing circuit that performs a multiplication operation between pieces of data of signals being inputted in time series and between pieces of data of phase information being inputted in time series.

### REFERENCE SIGNS LIST

1, 1a: digital calculation processing circuit, 2, 2a: shift setting register, 3, 3a: determination unit, 4: control unit, 5: first calculation unit, 6: second calculation unit, 7: aggregating calculation unit, 8: X register, 9: Y register, 10: setting unit, 501: data shifter, 502: first multiplier, 503: first adder, 504: first accumulator, 505: inverse data shifter, 601: second multiplier, 602: second adder, 603: second accumulator, 701: third adder, 702: limiter.

1. A digital calculation processing circuit comprising:
a first calculator and a second calculator each performing a calculation including multiplication of data being inputted in time series and data being inputted in time series, and cumulative addition of results of the multiplication;
a determinator determining whether each of the data to be inputted to the first calculator and the data to be inputted to the second calculator has a value greater than or equal to a specific positive value or a value less than or equal to a specific negative value;
a controller performing control to cause the first calculator to perform the calculation if a determination result of the determinator indicates that the value is greater than or equal to the specific positive value or is less than or equal to the specific negative value, and otherwise, to cause the second calculator to perform the calculation; and
an aggregating calculator generating output data by performing an addition operation on a result of the calculation of the first calculator and a result of the calculation of the second calculator, wherein
the first calculator includes:
a data shifter performing bit-shifting of input data by a set bit shift amount toward less significant bit positions, and performing reduction of a bit width of the input data by an amount of the bit-shifting;
a multiplier multiplying together pieces of output data from the data shifter;
a cumulative adder cumulatively adding up output data from the multiplier; and
an inverse data shifter performing bit-shifting of output data from the cumulative adder toward more significant bit positions to compensate the amount of the bit-shifting toward the less significant bit positions performed by the data shifter, and increasing a bit width thereof by the amount of the bit-shifting toward the more significant bit positions.

2. The digital calculation processing circuit according to claim 1, wherein the set bit shift amount, the specific positive value, and the specific negative value are externally set.
